(19) United States
(12) Patent Application Publication
(10) Pub. No.: US 2020/0303847 A1
(43) Pub. Date: Sep. 24, 2020

(54) CABLE LUG HAVING A COLLAR

(71) Applicant: Tyco Electronics Raychem GmbH, Ottobrunn (DE)

(72) Inventors: Torsten Friedrich, Martinsried (DE); Axel Winter, Munich (DE)

(73) Assignee: Tyco Electronics Raychem GmbH, Ottbrunn (DE)

(21) Appl. No.: 16/896,645

(22) Filed: Jun. 9, 2020

Related U.S. Application Data
(63) Continuation of application No. PCT/EP2018/086029, filed on Dec. 19, 2018.

(30) Foreign Application Priority Data
Dec. 21, 2017 (EP) 17209328.8

(51) Int. Cl. H01R 11/12; H01R 4/70; H01R 13/53

(52) U.S. Cl. CPC H01R 11/12; H01R 13/53; H01R 4/70

(57) ABSTRACT

A cable lug for terminating a cable and contacting an appliance includes a cable-side end section directly or indirectly contacting the cable, an appliance-side end section contacting the appliance, and a main body extending between the cable-side end section and the appliance-side end section. The main body has a collar that radially protrudes from the main body.

### CROSS-REFERENCE TO RELATED APPLICATIONS

This application is a continuation of PCT International Application No. PCT/EP2018/086029, filed on Dec. 19, 2018, which claims priority under 35 U.S.C. § 119 to European Patent Application No. 17209328.8, filed on Dec. 21, 2017.

### FIELD OF THE INVENTION

The present invention relates to a cable lug and, more particularly, to a cable lug for terminating an electric cable.

### BACKGROUND

A cable lug is generally first mounted onto a conductor of an electric cable. Such a cable lug is, for example, known from EP 2 311 146 B1. The cable lug is then inserted into an insulator body. A lubrication element may be used to facilitate insertion of the cable lug. In addition, the insulating body often is widened upon the insertion, to ensure a water-tight and electrical sealing between the insulator body and the cable. The lubrication and the widening of the insulator body may push the insulator body from the cable. This may lead to a misalignment of the cable lug and may render the electric connection of the cable lug to an appliance, such as a switchgear, cumbersome. The insulating body and the cable lug need to be held in position manually. This, in turn, can be quite cumbersome in the field, if there is not enough handling space.

### SUMMARY

A cable lug for terminating a cable and contacting an appliance includes a cable-side end section directly or indirectly contacting the cable, an appliance-side end section contacting the appliance, and a main body extending between the cable-side end section and the appliance-side end section. The main body has a collar that radially protrudes from the main body.

### BRIEF DESCRIPTION OF THE DRAWINGS

The invention will now be described by way of example with reference to the accompanying Figures, of which:

FIG. 1 is a sectional side view of a terminal assembly along a longitudinal axis of a cable lug of the terminal assembly;

FIG. 2 is a sectional side view of the terminal assembly of FIG. 1 taken along line II-II with an alternative insulator body;

FIG. 3 is a perspective view of a cable lug according to another embodiment;

FIG. 4 is another perspective view of the cable lug of FIG. 3;

FIG. 5 is a perspective view of a cable lug according to another embodiment; and

FIG. 6 is a sectional perspective view of the cable lug, taken along line VI-VI of FIG. 5.

### DETAILED DESCRIPTION OF THE EMBODIMENT(S)

In the following, the invention is explained in further detail by exemplary embodiments with reference to the drawings. In the drawings, the same reference numerals are used for elements that correspond to each other with respect to at least one of function and design. Moreover, it is to be understood that the combination of features shown in the figures and described herein below, is of exemplary nature only. Features of which the technical effect is not needed for a particular application can be omitted from the shown embodiments. Vice versa, features that are described above but are not shown to be comprised in the embodiments can be added, if the technical effect associated with that particular feature is needed for a specific application.

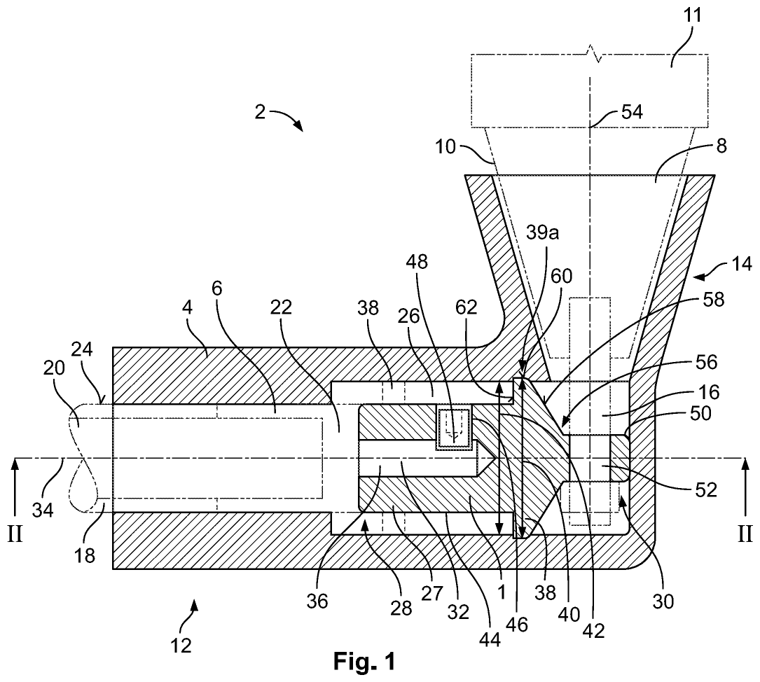

A cable lug 1 and a terminal assembly 2 according to an embodiment are shown in FIG. 1. The terminal assembly 2 includes the cable lug 1 and the insulator body 4.

In FIG. 1, the cable lug 1 is shown inserted in an insulator body 4 which may be made of insulating material, in particular of an insulating material having at least limited elasticity. In the shown embodiment, the cable lug 1 is inserted into a cable lug receptacle 6 of the insulator body 4. The insulator body 4 has an appliance receptacle 8 for receiving an appliance-side connector 10 which is only schematically indicated in FIG. 1. The appliance-side connector 10 may be part of an appliance 11, such as a switchgear. If the insulator body 4 is to have shielding capabilities, the material of the insulator body 4 may be doped with a conductive filler and/or comprise at least one layer made from conductive material.

The insulator body 4, as shown in FIG. 1, has an overall L-shape with two legs 12, 14 which may substantially extend perpendicular to one another. The cable lug receptacle 6 is located in a first leg 12, whereas the appliance receptacle 8 is arranged in a second leg 14. The L-shape may also be part of a larger insulator body 4 of a more complicated shape.

As shown in FIG. 1, the cable lug receptacle 6 and the appliance receptacle 8 intersect one another, so that the cable lug receptacle 6 opens into the appliance receptacle 8. This allows establishing an electric connection within the insulator body 4 between the cable lug 1 and the appliance-side connector 10 e.g. using a bolt 16 for securing the contact between the appliance-side connector 10 and the cable lug 10.

The cable lug 1 is mounted to a cable 18 having a conductor 20 either directly or indirectly. For mounting of the cable lug 1 onto the cable 18, an adaptor or alignment element 22 may be arranged between the cable 18 and the cable lug 1. The insulator body 4 may sealingly abut an outer surface 24 of the cable 18 in the cable lug receptacle 6, so that both an interior 26 of the terminal assembly 2 can be sealed off from dirt and moisture, and an electrically sealed interface is guaranteed. A similar sealing may be affected between the insulator body 4 and the appliance-side connector 10.

The cable lug 1, as shown in FIG. 1, has a main body 27, a cable-side end section 28 facing the cable 18 and an appliance side end section 30 facing away from the cable 18 and being located at the side where the appliance-side connector 10 is to be connected to the cable lug 1. The main body 27 is located between the cable-side end section 28 and the appliance-side end section 30. The main body 27 may be from a metal, such as copper or aluminum or an alloy containing at least one of copper and aluminum.

As shown in FIG. 1, the cable lug 1 or at least the main body 27 may have substantially rotational symmetry and be elongated in a direction of a longitudinal axis 32 which may coincide with or at least be parallel to an axis 34 of the cable lug receptacle 6. The cable-side end section 28 has an opening 36 which may be parallel or even coaxial to the longitudinal axis 32 and extend into the cable lug 1 towards the appliance-side end section 30. The opening 36 is configured to receive at least one of the conductor 20 of the cable 18 and the adaptor 22. The longitudinal axis 32 extends from the cable-side end section 28 to the appliance-side end section 30.

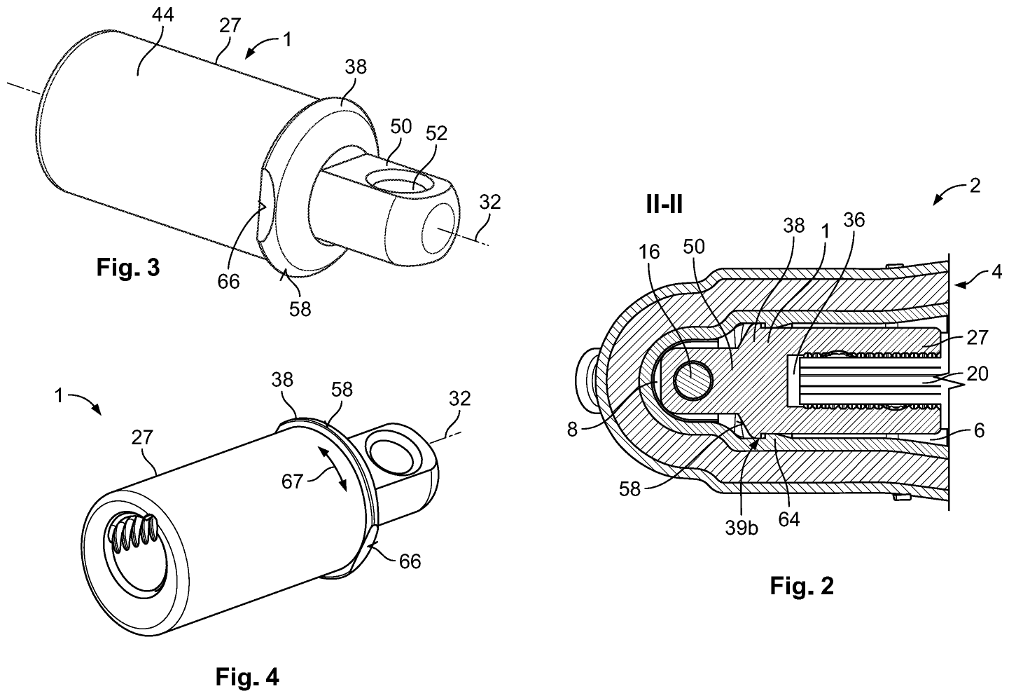

In order to fix the position of the cable lug 1 securely within the cable lug receptacle 6, at least one collar 38 may be provided, as shown in FIG. 1. The collar 38 is located on the main body 27 and radially protrudes from the main body 27, i.e. between the cable-side end section 28 and the appliance-side end section 30. The collar 38 fastens the cable lug 1 onto the insulator body 4 by forming at least one of a friction lock 39a, shown in FIG. 1, and a form lock 39b, shown in FIG. 2. At least one of the collar 38 and the insulator body 4 is radially deformed as the collar 38 has an outer diameter 40 which is larger than an inner diameter 42 of the cable lug receptacle 6 at the final resting position of the cable lug 1 within the cable lug receptacle 6, when the cable lug 1 is fully inserted and e.g. abuts the appliance receptacle 8 with its appliance-side end section 30 as shown. Due to the elastic deformation, an elastic restoring force is generated, which creates a normal force acting between the collar 38 and the insulator body 4. The normal force in turn and thus creates friction lock 39a which holds the cable lug in place. At the same time, the collar 38 serves to center the cable lug 1 within the cable lug receptacle 6. The cross-section of the collar 38 perpendicular to the longitudinal axis 32 may be circular, elliptical, ovoid or polygonal, or of any other shape, and in particular complementary to the cross-section of the interior of the insulator body 4.

In FIG. 1, it is only schematically shown that the collar 38 is pressed into the deformed elastic material of the insulator body 4. Of course, it is also possible that only the collar 38 is deformed or that both the collar 38 and the insulator body 4 are deformed. This will depend on the relative stiffnesses of the material of the collar 38 and the material of the insulator body 4 at the location where the collar 38 comes to rest within the cable lug receptacle 6.

The main body 27, as shown in FIG. 1, has a cylindrical section 44, which may in particular have a circular cross section. The cylindrical section 44 may surround the opening 36. The cylindrical section 44 may be located between the appliance-side end section 30 and the collar 38. In the cylindrical section 44, at least one radially extending threaded hole 46 may be located, in which a screw 48 may be received to clamp whatever is received in the opening 36. In order to avoid damage of the insulator body 4 due to any part of the screw 48 protruding from the cylindrical section 44 or due to the rim of the threaded hole 46, the insulator body 4 is spaced apart radially from the cylindrical section 44 at the location, where the threaded hole 46 is arranged. Alternatively or additionally, the cylindrical section 44 may be a crimp section, which is configured to be crimped around the conductor 20.

The collar 38 ensures that the insulator body 4 cannot touch the threaded hole 46 or the screw 48, and/or a sharp edge of a crimped cylindrical section 44, by acting as a spacer between the cylindrical section 44 and the insulator body 4. The collar 38 may be located at or close to the end of the cylindrical section 44 which end faces towards the appliance-side end section 30. The end may be spaced apart between 0.5 and 2 material thicknesses from the collar 38, where material thickness is determined in the longitudinal direction 32.

As indicated by the phantom lines in FIG. 1, at least one or more additional collars 38 may be provided spaced apart from the collar 38 in the longitudinal direction 32. This allows keeping the insulator body 4 spaced apart from the cable lug 1 at all critical sections, where the insulator body 4 may be damaged. The collar 38 or an additional collar 38 may be located at any other position in the longitudinal direction 32, e.g. at the cable-side end 28 or between the cable-side end 28 and the appliance-side end 30.

As shown in FIG. 1, the cable lug 1 has a protrusion 50, which protrudes from the main body 27 along the longitudinal axis 32. In an embodiment, the cylindrical section 44 if present, the collar 38 and the protrusion 50 are all coaxial. The protrusion 50 may have a smaller outer diameter than the cylindrical section 44, if present, and the cylindrical section 44 may have a smaller outer diameter than the collar 38; the appliance-side end section 30 has a smaller outer diameter than the cable-side end section 28. The collar 38 may constitute the largest outer diameter 40 of the cable lug 1.

The protrusion 50 is an electrical connector which allows to establish electric contact with the appliance or the appliance connector 10. The protrusion 50 has an opening 52, which may be a threaded or unthreaded through hole. The axis of the opening 52 coincides with an axis 54 of the appliance receptacle 8; perpendicular to the longitudinal direction 32. The bolt 16 may reach through the opening 52.

As shown in FIG. 1, the collar 38 may be arranged between the cable-side end section 28 and the appliance-side end section 30 of the cable lug 1. In particular, the collar 38 may be located at a base 56 of the protrusion 50, where the protrusion 50 joins the main body 27. A front face 58 of the collar 38 establishes a transition from the protrusion 50 to an outer, circumferential face 60 of the collar 38. The front face 58 faces radially outwards and extends circumferentially around the longitudinal direction 32. The front face 58 may be slanted away from the cable-side end section 28 towards the appliance-side end section 30 with decreasing radius to facilitate insertion of the cable lug 1 into the insulator body 4. The front face 58 may be dome-shaped and/or be frustoconical at least in parts, in particular at its radially outer end. A rear face 62 of the collar 38 faces towards the cable-side end section 28. The rear face 62 may be substantially perpendicular to the longitudinal axis 32 or, e.g. in sections, be slanted towards the appliance-side end section 30. The collar 38 can be used to align a position of the protrusion 50 with respect to the insulating body 4.

As described above, the cable lug 1 may be secured within the cable lug receptacle 6 by at least one of a form lock 39b and a friction lock 39a. In FIG. 2, an exemplary embodiment is shown, which instead of or in addition to the frictional lock 39a shown in FIG. 1 uses a form or positive lock 39b. To establish such a form lock 39b, the insulator body 4 has at least one locking element 64 which is configured to engage the collar 38 e.g. by a snap-fit. For example, the locking element 64 may be a radially inwardly protruding locking protrusion which is slanted at its side facing away from the appliance receptacle 8 to facilitate passing of the cable lug 1, in particular of the collar 38. To improve centering of the cable lug 1 within the cable lug receptacle 6, the collar 38 abuts the interior of the cable lug receptacle 6 and the locking element 64 abuts the exterior of the cable lug 1 when the form lock 39b has been established. Of course, other locking elements 64 than shown in FIG. 2 may be used, such as, for example, a circumferential groove in the cable lug receptacle 6, in which the collar 38 is received.

As can be seen further in FIG. 2, the insulator body 4 may comprise several layers of different material.

FIGS. 3 and 4 show a cable lug 1, in which the collar 38 does not have a circumferential face 60, or at least a substantial circumferential face 60, but rather forms a circumferential, tapering rib due to a dome-shaped front face 58. The collar 38 is formed monolithically with the main body 27. Nonetheless, the collar 38 and the remainder of the cable lug 1 need not to be of the same material. For example, one of a ready-made cable lug 1 or/and collar 38 may be put into a mold and the other one of the collar 38 and the cable lug 1 may be cast onto the already existing part.

It is further shown in FIGS. 3 and 4 that the collar 38 may have at least one flat section 66, which faces radially outwards and in which the outer diameter of the collar 38 is reduced. There may be two or more such flat sections 66 along the circumferential direction 67. The flat sections 66 may be arranged at diametrically opposed locations with respect to the longitudinal axis 32. The at least one flat section 66 facilitates handling of the cable lug 1.

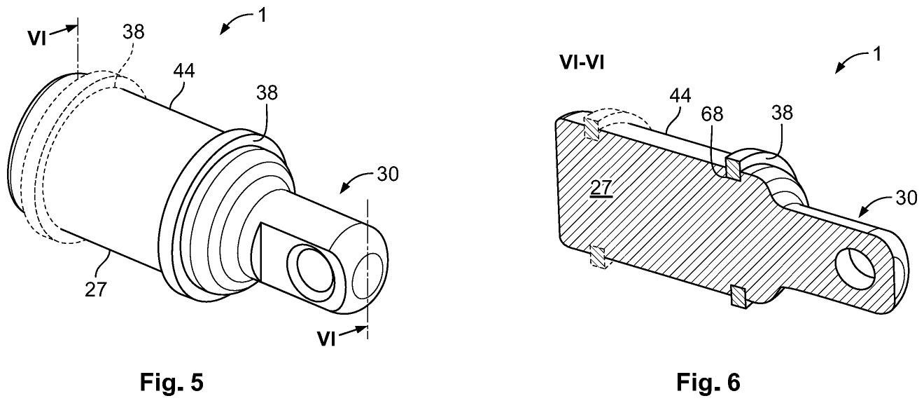

Another embodiment of the cable lug 1 is shown in FIGS. 5 and 6. Here, the collar 38 is a separate part which is fixed or fastened onto the remainder of the cable lug 1. In the embodiment of FIGS. 5 and 6, the collar 38 is a ring. As shown in FIG. 6, the cable lug 1 in particular the main body 27 may comprise a circumferential groove 68 in which the collar 38 may be received. The groove 68 may be located in the cylindrical section 44, in particular at an end of the cylindrical section 44 which is located towards the appliance-side end section 30. This configuration allows for a greater variability in the materials used for the collar 38 on one hand and the remainder of the cable lug 1 on the other. For example, the collar 38 may be made of a resin or plastic material, whereas the remainder of the cable lug 1 may be made from an electrical conductor such as copper, aluminum or an alloy containing at least one of copper and aluminum.

What is claimed is:

1. A cable lug for terminating a cable and contacting an appliance, comprising:
a cable-side end section directly or indirectly contacting the cable;
an appliance-side end section contacting the appliance; and
a main body extending between the cable-side end section and the appliance-side end section, the main body has a collar that radially protrudes from the main body.

2. The cable lug of claim 1, wherein the collar is a separate part that is fastened to the main body.

3. The cable lug of claim 2, wherein the collar is received in a groove that extends at least in sections circumferentially around a longitudinal axis of the cable lug, the longitudinal axis extending from the cable-side end section to the appliance-side end section.

4. The cable lug of claim 1, wherein the collar is made from a different material than the main body.

5. The cable lug of claim 1, wherein the collar is made from a resin or plastic material.

6. The cable lug of claim 1, wherein the appliance-side end section has a protrusion extending from the main body along a longitudinal axis of the cable lug.

7. The cable lug of claim 6, wherein the collar is located at a base where the protrusion joins the main body.

8. The cable lug of claim 7, wherein a front face of the collar facing toward the appliance-side end section is slanted at least in sections relative to the longitudinal axis.

9. The cable lug of claim 1, wherein the main body has a cylindrical section extending from the cable-side end section toward the appliance-side end section.

10. The cable lug of claim 9, wherein the collar is located on an end of the cylindrical section closer to the appliance-side end section.

11. The cable lug of claim 1, wherein the appliance-side end section has a smaller outer diameter than the cable-side end section.

12. The cable lug of claim 11, wherein the collar has a larger outer diameter than the cable-side end section.

13. The cable lug claim 1, wherein the collar has a rear face facing toward the cable-side end section, the rear face extending at least one of perpendicular to a longitudinal axis of the cable lug and slanted toward the appliance-side end section.

14. The cable lug of claim 1, wherein the appliance-side end section is coaxial to at least one of the cable-side end section and the collar.

15. A terminal assembly, comprising:
a cable lug including a cable-side end section, an appliance-side end section, and a main body extending between the cable-side end section and the appliance-side end section, the main body has a collar that radially protrudes from the main body; and
an insulator body having a cable lug receptacle receiving the cable lug and an appliance receptacle receiving an appliance-side connector complementary to the appliance-side end section of the cable lug, the cable lug is inserted in the cable lug receptacle and is secured along a longitudinal axis of the cable lug by at least one of a friction lock and a form lock between the collar and the cable lug receptacle.

16. The terminal assembly of claim 15, wherein at least one of the collar and the cable lug receptacle is deformed elastically in a radial direction to generate the friction lock.

17. The terminal assembly of claim 15, wherein the cable lug receptacle has a locking element shaped complementary to the collar to generate the form lock.

18. The terminal assembly of claim 15, wherein the cable-side end section has a radial hole for insertion of a screw.

19. The terminal assembly of claim 18, wherein the insulator body is spaced apart from the radial hole when the cable lug is inserted into the cable lug receptacle.
